(19) United States
(12) Patent Application Publication
(10) Pub. No.: US 2023/0206059 A1
(43) Pub. Date: Jun. 29, 2023

(54) TRAINING BRAIN EMULATION NEURAL NETWORKS USING BIOLOGICALLY-PLAUSIBLE ALGORITHMS

(71) Applicant: X Development LLC, Mountain View, CA (US)

(72) Inventors: Sarah Ann Laszlo, Mountain View, CA (US); Lam Thanh Nguyen, Mountain View, CA (US); Baihan Lin, New York, NY (US)

(21) Appl. No.: 17/564,536

(22) Filed: Dec. 29, 2021

(51) Int. Cl. G06N 3/08; G06N 3/063

(52) U.S. Cl. CPC G06N 3/08; G06N 3/063

(57) ABSTRACT

In one aspect, there is provided a method performed by one or more data processing apparatus for training a neural network, the method including: obtaining a set of training examples, where each training example includes: (i) a training input, and (ii) a target output, and training the neural network on the set of training examples. Training the neural network can include, for each training example: processing the training input using the neural network to generate a corresponding training output, updating current values of at least a set of encoder sub-network parameters and a set of decoder sub-network parameters by a supervised update, and updating current values of at least a set of brain emulation sub-network parameters by an unsupervised update based on correlations between activation values generated by artificial neurons of the neural network during processing of the training input by the neural network.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a method implemented as computer programs on one or more computers in one or more locations for training a neural network using biologically-plausible algorithms.

Throughout this specification, a “synaptic connectivity graph” can refer to a graph that represents a biological connectivity between neuronal elements in a brain of a biological organism. A “neuronal element” can refer to an individual neuron, a portion of a neuron, a group of neurons, or any other appropriate biological neuronal element, in the brain of the biological organism. The synaptic connectivity graph can include multiple nodes and edges, where each edge connects a respective pair of nodes. A “sub-graph” of the synaptic connectivity graph can refer to a graph specified by: (i) a proper subset of the nodes of the synaptic connectivity graph, and (ii) a proper subset of the edges of the synaptic connectivity graph.

For convenience, throughout this specification, a neural network having one or more neural network layers having parameters that, when initialized, represent a synaptic connectivity graph, or a sub-graph of the synaptic connectivity graph, can be referred to as a “brain emulation” neural network. A set of parameters of a neural network that, when initialized, represent biological connectivity in the brain of a biological organism can be referred to as “brain emulation parameters.” Identifying an artificial neural network as a “brain emulation” neural network is intended only to conveniently distinguish such neural networks from other neural networks (e.g., with entirely hand-engineered architectures), and should not be interpreted as limiting the nature of the operations that may be performed by the neural network or otherwise implicitly characterizing the neural network.

According to a first aspect, there is provided a method performed by one or more data processing apparatus for training a neural network, the method including: obtaining a set of training examples, where each training example includes: (i) a training input, and (ii) a target output, and training the neural network on the set of training examples.

Training the neural network on the set of training examples includes, for each training example: processing the training input from the training example using the neural network to generate a corresponding training output, including processing the training input using an encoder sub-network of the neural network, in accordance with a set of encoder sub-network parameters, to generate an embedding of the training input; processing the embedding of the training input using a brain emulation sub-network of the neural network, in accordance with a set of brain emulation sub-network parameters, to generate a brain emulation sub-network output, where the brain emulation sub-network parameters, when initialized, represent biological connections between multiple biological neuronal elements in a brain of a biological organism, and processing the brain emulation sub-network output using a decoder sub-network of the neural network, in accordance with a set of decoder sub-network parameters, to generate the training output, updating current values of at least the set of encoder sub-network parameters and the set of decoder sub-network parameters by a supervised update based on gradients of an objective function that measures an error between: (i) the training output, and (ii) the target output for the training example, and updating current values of at least the set of brain emulation sub-network parameters by an unsupervised update based on correlations between activation values generated by artificial neurons of the neural network during processing of the training input, by the neural network, to generate the training output.

In some implementations, each brain emulation sub-network parameter corresponds to a respective pair of biological neuronal elements in the brain of the biological organism, and where a value of each brain emulation sub-network parameter, when initialized, represents a strength of a biological connection between the corresponding pair of biological neuronal elements in the brain of the biological organism.

In some implementations, the method further includes updating current values of at least the set of brain emulation sub-network parameters by the supervised update based on gradients of the objective function that measures the error between: (i) the training output, and (ii) the target output for the training example.

In some implementations, each brain emulation sub-network parameter corresponds to a respective pair of artificial neurons in the brain emulation sub-network.

In some implementations, updating current values of at least the set of brain emulation sub-network parameters by the unsupervised update based on correlations between activation values generated by the artificial neurons of the neural network during processing of the training input, by the neural network, to generate the training output includes: receiving the activation values generated by the artificial neurons of the brain emulation sub-network during processing of the training input, determining, for each brain emulation sub-network parameter in the set of brain emulation sub-network parameters, a correlation between the respective activation values of the artificial neurons corresponding to the brain emulation sub-network parameter, determining, for each brain emulation sub-network parameter and based on the correlation of the respective activation values, a new value of the brain emulation sub-network parameter, and updating the current value of each brain emulation sub-network parameter in the set of brain emulation sub-network parameters to the respective new value.

In some implementations, determining, for each brain emulation sub-network parameter and based on the correlation of the respective activation values, the new value of the brain emulation sub-network parameter, includes: determining the new value based, at least in part, on a product of a learning rate and the activation values of the pair of artificial neurons in the brain emulation sub-network that correspond to the brain emulation sub-network parameter, wherein the product characterizes a measure of correlation of the respective activation values of the pair of artificial neurons.

In some implementations, the learning rate is a hyperparameter of the neural network.

In some implementations, the product of the learning rate and the activation values of the pair of artificial neurons in the brain emulation sub-network is normalized using an L2 norm.

In some implementations, determining the new value of the brain emulation sub-network parameter based, at least in part, on the product of the learning rate and the activation values of the pair of artificial neurons in the brain emulation sub-network that correspond to the brain emulation sub-network parameter includes: determining the new value of the brain emulation sub-network parameter by combining the current value of the brain emulation sub-network parameter, and the product of the learning rate and the activation values of the pair of artificial neurons in the brain emulation sub-network that correspond to the brain emulation sub-network parameter.

In some implementations, receiving the activation values generated by the artificial neurons of the brain emulation sub-network during processing of the training input includes: receiving activation values generated by the artificial neurons of the brain emulation sub-network in a free state of the neural network, and receiving activation values generated by the artificial neurons of the brain emulation sub-network in a clamped state of the neural network.

In some implementations, determining, for each brain emulation sub-network parameter and based on the correlation of the respective activation values, the new value of the brain emulation sub-network parameter includes: determining the new value of the brain emulation sub-network parameter based, at least in part, on the activation values generated by the artificial neurons of the brain emulation sub-network that correspond to the brain emulation sub-network parameter in the free state of the neural network, the activation values generated by the artificial neurons of the brain emulation sub-network that correspond to the brain emulation parameter in the clamped state of the neural network, and a learning rate.

In some implementations, the set of encoder sub-network parameters and the set of decoder sub-network parameters each include brain emulation parameters that, when initialized, represent biological connections between multiple biological neuronal elements in the brain of the biological organism.

In some implementations, the method further includes: updating current values of the brain emulation parameters included in the set of encoder sub-network parameters and the set of decoder sub-network parameters by the unsupervised update based on correlations between activation values generated by artificial neurons of the neural network during processing of the training input, by the neural network, to generate the training output.

In some implementations, the set of brain emulation sub-network parameters are determined from a synaptic resolution image of at least a portion of the brain of the biological organism, the determining including: processing the synaptic resolution image to identify: (i) multiple biological neuronal elements, and (ii) multiple biological connections between pairs of biological neuronal elements, determining a respective value of each brain emulation sub-network parameter, including: setting a value of each brain emulation sub-network parameter that corresponds to a pair of biological neuronal elements in the brain that are not connected by a biological connection to zero, and setting a value of each brain emulation sub-network parameter that corresponds to a pair of biological neuronal elements in the brain that are connected by a biological connection based on a proximity of the pair of biological neuronal elements in the brain.

In some implementations, each biological neuronal element of multiple biological neuronal elements is a biological neuron, a part of a biological neuron, or a group of biological neurons.

In some implementations, the set of brain emulation sub-network parameters are arranged in a two-dimensional weight matrix having multiple rows and multiple columns, where each row and each column of the weight matrix corresponds to a respective biological neuronal element from multiple biological neuronal elements, and each brain emulation sub-network parameter in the weight matrix corresponds to a respective pair of biological neuronal elements in the brain of the biological organism, the pair including: (i) the biological neuronal element corresponding to a row of the brain emulation sub-network parameter in the weight matrix, and (ii) the biological neuronal element corresponding to a column of the brain emulation sub-network parameter in the weight matrix.

In some implementations, each brain emulation sub-network parameter of the weight matrix that corresponds to a respective pair of biological neuronal elements that are not connected by a biological connection in the brain of the biological organism has value zero, and each brain emulation sub-network parameter of the weight matrix that corresponds to a respective pair of biological neuronal elements that are connected by a biological connection in the brain of the biological organism has a respective non-zero value characterizing an estimated strength of the biological connection.

In some implementations, updating current values of at least the set of brain emulation sub-network parameters by the unsupervised update based on correlations between activation values generated by artificial neurons of the neural network during processing of the training input, by the neural network, to generate the training output, includes: updating only the brain emulation parameters of the weight matrix having non-zero values.

According to a second aspect, there is provided a system that includes one or more computers, and one or more storage devices communicatively coupled to the one or more computers, where the one or more storage devices store instructions that, when executed by the one or more computers, cause the one or more computers to perform operations of any preceding aspect.

According to a third aspect, there are provided one or more non-transitory computer storage media storing instructions that when executed by one or more computers cause the one or more computers to perform operations of any preceding aspect.

Particular embodiments of the subject matter described in this specification can be implemented so as to realize one or more of the following advantages.

The method described in this specification can train a neural network by using a supervised update for updating parameter values of an encoder sub-network and a decoder sub-network, and a biologically-plausible unsupervised update for updating parameter values of a brain emulation sub-network. Each brain emulation parameter of the brain emulation sub-network, when initialized, can represent a strength of a biological connection between a corresponding pair of biological neuronal elements in the brain of a biological organism. The brains of biological organisms may be adapted by evolutionary pressures to be effective at solving certain tasks, e.g., classifying objects or generating robust object representations, and neural networks that include brain emulation sub-networks may therefore share this capacity to effectively solve tasks.

However, because the training approach can have a significant impact on the performance of a neural network at a machine learning task after it has been trained, it may be difficult to optimally harness the effectiveness of brain emulation neural networks by using solely conventional (e.g., non-biological) training methods. The method described in this specification can train the brain emulation neural network in a biologically-plausible manner, e.g., using methods that are at least partially derived from neuroscientific or biological principles, and therefore can better harness the effectiveness of the brain emulation neural network, inherited from evolutionary processes, at performing the machine learning task. Furthermore, the biologically-plausible methods described in this specification may require less training data, fewer training iterations, or both, to train the brain emulation neural network, when compared to other training methods, e.g., artificial, or non-biological, training methods. This may, in turn, lead to a reduced consumption of computational resources (e.g., memory and computing power) by the brain emulation neural network during training. As a result of biologically-plausible training, brain emulation neural networks may perform certain machine learning tasks more effectively, e.g., with higher accuracy, when compared to brain emulation neural networks trained using non-biological training methods.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network computing system that includes a neural network that can be trained using biologically-plausible training methods.

FIG. 2 illustrates an example of a biologically-plausible training method.

FIG. 3 illustrates another example of a biologically-plausible training method.

FIG. 4 is a flow diagram of an example process for training a neural network using a biologically-plausible training method.

FIG. 5 is an example data flow for generating a brain emulation neural network architecture using a synaptic connectivity graph.

FIG. 6 is a block diagram of an example architecture mapping system.

FIG. 7 illustrates an example adjacency matrix and an example weight matrix of a brain emulation neural network layer determined using a synaptic connectivity graph.

FIG. 8 is an example data flow for generating a synaptic connectivity graph based on the brain of a biological organism.

FIG. 9 is a block diagram of an example computer system.

Like reference numbers and designations in the various drawings indicate like elements.

### DETAILED DESCRIPTION

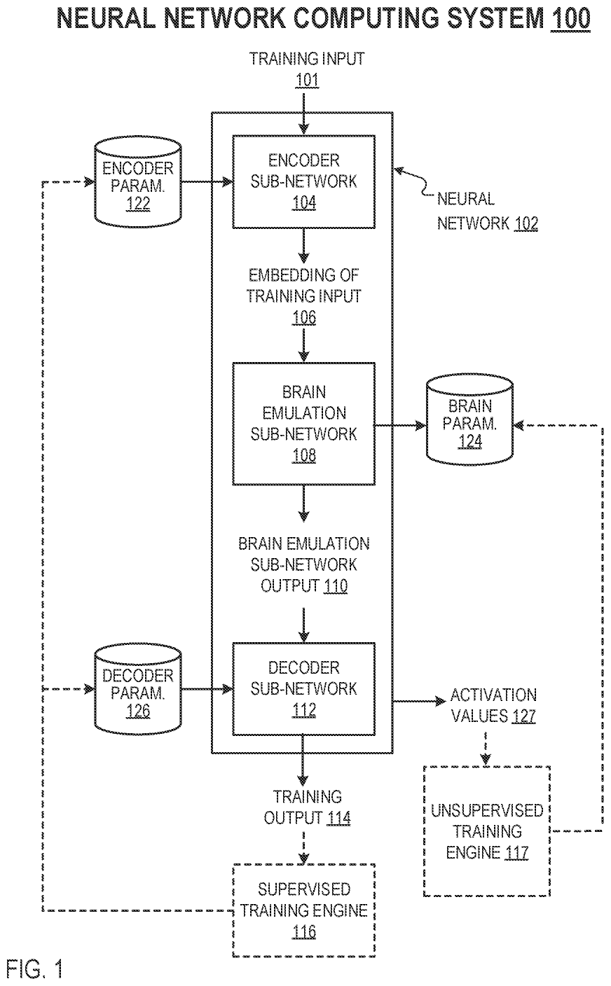

FIG. 1 is a block diagram of an example neural network computing system 100 that includes a neural network 102 that can be trained using biologically-plausible training methods. The system 100 is an example of a system implemented as computer programs on one or more computers in one or more locations in which the systems, components, and techniques described below are implemented.

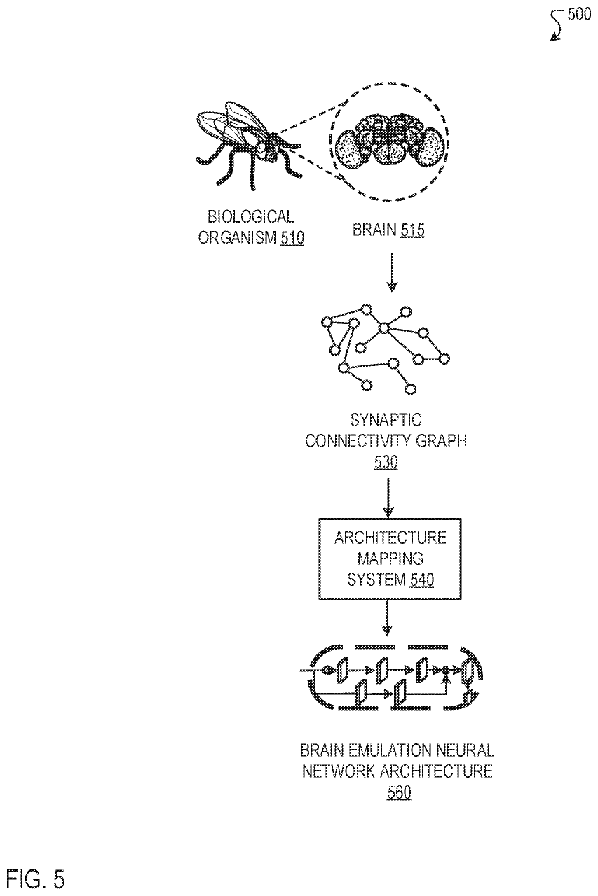

The neural network 102 can include: (i) an encoder sub-network 104, (ii) a brain emulation sub-network 108, and (iii) a decoder sub-network 112. Throughout this specification, a “sub-network”refers to a neural network that is included as part of another, larger neural network. Further, throughout this specification, a “brain emulation sub-network” can refer to a neural network having brain emulation parameters that, when initialized, represent a synaptic connectivity graph (or a sub-graph thereof). As will be described in more detail below with reference to FIG. 5, the synaptic connectivity graph can represent connectivity between biological neuronal elements in the brain of a biological organism. As used throughout this document, the “brain” can refer to any amount of nervous tissue from a nervous system of the biological organism, and nervous tissue can refer to any tissue that includes neurons (i.e., nerve cells). The biological organism can be, e.g., a fly, a fish, a worm, a cat, a mouse, or a human.

A “neuronal element” can refer to an individual neuron, a portion of a neuron, a group of neurons, or any other appropriate biological element in the brain of the biological organism. The synaptic connectivity graph can include multiple nodes and multiple edges, where each edge connects a respective pair of nodes. In one example, each node in the synaptic connectivity graph can represent an individual neuron, and each edge connecting a pair of nodes in the graph, can represent a respective synaptic connection between the corresponding pair of individual neurons.

In some implementations, the synaptic connectivity graph can be an “over-segmented” synaptic connectivity graph, e.g., where at least some nodes in the graph represent a portion of a neuron, and at least some edges in the graph connect pairs of nodes that represent respective portions of neurons. In some implementations, the synaptic connectivity graph can be a “contracted” synaptic connectivity graph, e.g., where at least some nodes in the graph represent a group of neurons, and at least some edges in the graph represent respective connections (e.g., nerve fibers) between such groups of neurons. In some implementations, the synaptic connectivity graph can include features of both the “over-segmented” graph and the “contracted” graph. Generally, the synaptic connectivity graph can include nodes and edges that represent any appropriate neuronal element, and any appropriate connection between a pair of neuronal elements, respectively, in the bran of the biological organism. The components of the neural network computing system 100 will be described in more detail next.

The neural network 102 can be configured to process a network input to generate a network output, e.g., a prediction for the network input. For example, during training, the neural network 102 can be configured to receive a training input 101, and process it to generate a training output 114.

Specifically, the encoder sub-network 104 can be configured to receive the training input 101 and process it in accordance with a set of encoder sub-network parameters 122 to generate an embedding of the training input 106. An “embedding” generally refers to, e.g., an ordered collection of numerical values such as, e.g., a vector or a matrix of numerical values.

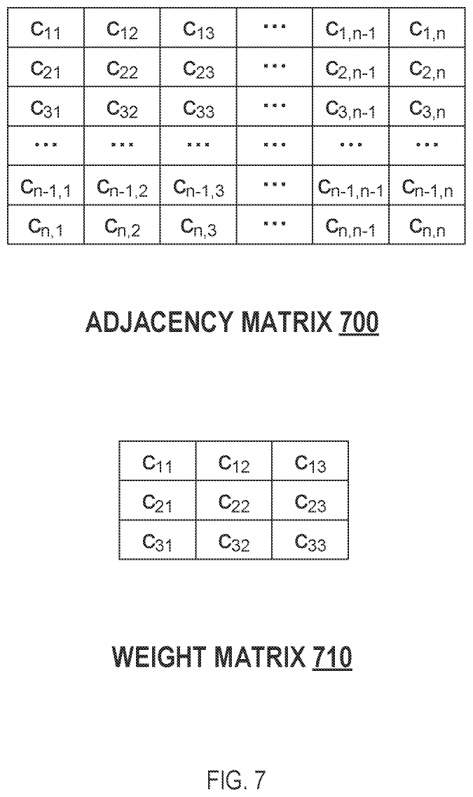

The brain emulation sub-network 108 can be configured to receive the embedding of the training input 106 and process it in accordance with a set of brain emulation parameters 124 to generate the brain emulation sub-network output 110. As will be described in more detail below with reference to FIG. 7, each brain emulation parameter 124 of the brain emulation sub-network 108, when initialized, can represent a strength of a biological connection between a pair of biological neuronal elements in the brain of a biological organism. The brain emulation parameters 124 can be represented by a weight matrix (e.g., the weight matrix 710 in FIG. 7), and each element of the weight matrix can be a respective brain emulation parameter 124 of the brain emulation sub-network 108. The brain emulation sub-network 108 can apply the weight matrix (e.g., perform a matrix multiplication with the weight matrix) to a brain emulation sub-network input (e.g., the embedding of the training input 106), to generate a corresponding brain emulation sub-network output (e.g., the output 110).

The decoder sub-network 112 can be configured to receive the brain emulation sub-network output 110 and process it in accordance with a set of decoder sub-network parameters 126 to generate the training output 114.

The encoder sub-network 104, the brain emulation sub-network 108, and the decoder sub-network 112 can have any appropriate neural network architecture that enables them to perform their prescribed function, e.g., they can include fully-connected layers, convolutional layers, attention layers, or any other appropriate neural network layers. In some implementations, the system 100 can include multiple brain emulation sub-networks, each having a set of brain emulation parameters that, when initialized, can represent the synaptic connectivity graph.

In some implementations, each of the brain emulation sub-networks can include a different set of brain emulation parameters. For example, the brain emulation parameters of a first brain emulation sub-network, when initialized, can represent, e.g., a visual processing region of the brain of the biological organism, while the brain emulation parameters of a second brain emulation sub-network, when initialized, can represent, e.g., an audio processing region of the brain of the biological organism. Furthermore, in some implementations, the brain emulation parameters of different brain emulation sub-networks, when initialized, can represent the brains of different biological organisms. For example, the brain emulation parameters of a first brain emulation sub-network, when initialized, can represent, e.g., the brain of a fly, while the brain emulation parameters of a second brain emulation sub-network, when initialized, can represent, e.g., the brain of a cat. The system 100 can generally include any number and configuration of brain emulation sub-networks having brain emulation parameters that, when initialized, can represent the brain of any number and type of respective biological organisms.

The neural network computing system 100 can further include: (i) a supervised training engine 116, and (ii) an unsupervised training engine 116. Each of the training engines 116, 117 can be configured to train one or more components of the system 100 over multiple training iterations. That is, at each training iteration, the supervised training engine 116 and the unsupervised training engine 117 can be configured to update at least some of the parameters of one or more respective components of the neural network computing system 100. More specifically, at each training iteration, the supervised training engine 116 can perform supervised updates of the parameter values, and the unsupervised training engine can perform unsupervised updates of the parameter values, as will be described in more detail below.

The supervised training engine 116 can train one or more components of the system 100 on training data that includes a set of training examples. Each training example can specify: (i) a training input 101, and (ii) a target output. The target output can represent, e.g., the output that should be generated by the neural network 102 by processing the training input 101. Generally, the training input 101 and the corresponding target output can be of any appropriate type. In one example, the training input can include, e.g., an image, and the target output can include, e.g., a segmentation of the image defining a target region of the image.

In some implementations, the supervised training engine 116 can train (e.g., in a supervised manner) the encoder parameters 122 of the encoder sub-network 104 and the decoder parameters 126 of the decoder sub-network 112. At each training iteration, the supervised training engine 116 can sample a batch of training examples from the training data, and process the training inputs 101 specified by the training examples using the neural network 102 to generate corresponding training outputs 114. In particular, for each training input 101, the neural network 102 processes the training input 101 using the encoder parameter values 112 of the encoder sub-network 104 to generate the embedding of the training input 106. The neural network 102 processes the embedding of the training input 106 using brain emulation parameters 124 of the brain emulation sub-network 108, to generate the brain emulation sub-network output 110. Further, the neural network processes the brain emulation sub-network output 110 using the decoder parameter values 126 of the decoder sub-network 112 to generate the training output 114 corresponding to the training input 101.

At each training iteration, the supervised training engine 116 can perform a supervised update of the encoder parameter values 122 and a supervised update of the decoder parameter values 126, e.g., adjust the parameter values 122, 126 to optimize an objective function that measures a similarity between: (i) the training outputs 114 generated by the neural network 102, and (ii) the target outputs specified by the training examples. The objective function can be, e.g., a cross-entropy objective function, a squared-error objective function, or any other appropriate objective function. To optimize the objective function, the supervised training engine 116 can determine gradients of the objective function with respect to the encoder parameter values 122 and the decoder parameter values 126, e.g., using backpropagation techniques. The supervised training engine 116 can then use the gradients to adjust the encoder parameter values 122 and the decoder parameter values 126, e.g., using any appropriate gradient descent optimization technique, e.g., an RMSprop or Adam gradient descent optimization technique.

In some implementations, in addition to training the encoder parameter values 122 and the decoder parameter values 126, the supervised training engine 116 can also train the brain emulation parameters 124 of the brain emulation sub-network 108, e.g., perform supervised updates of the values of the brain emulation parameters 124 over multiple training iterations. That is, after initial values for the brain emulation parameters 124 have been determined based on the weight values of the edges in the synaptic connectivity graph, at each training iteration, the supervised training engine 116 can perform a supervised update of the weights of the brain emulation parameters in a similar way as described above, e.g., using backpropagation and stochastic gradient descent.

As described above, the brain emulation sub-network parameters 124 can be represented by the weight matrix, and each element of the weight matrix can be a respective brain emulation parameter 124 of the brain emulation sub-network 108. During training of the brain emulation sub-network 108 (e.g., by the supervised engine 116, the unsupervised engine 117, or both) the system 100 can, optionally, only update the non-zero values of the weight matrix representing the brain emulation sub-network parameters 124. In other words, the system 100 can modify the “strength” of the existing connections in the synaptic connectivity graph (e.g., from which the weight matrix is derived, as described in more detail below with reference to FIG. 7), without generating new connections in the graph. Furthermore, in some implementations, the weight matrix of the brain emulation sub-network 108 can be a “sparse” matrix, e.g., can include more than a threshold number or proportion of zero-value brain emulation sub-network parameters 124. By updating only the non-zero values of brain emulation sub-network parameters 124, the weight matrix is kept sparse, which can allow to maintain computational efficiency during training of the brain emulation sub-network 108.

The supervised training engine 116 can use any of a variety of regularization techniques during training of the neural network 102. For example, the training engine 116 can use a dropout regularization technique, such that certain artificial neurons of the neural network 102 are “dropped out” (e.g., by having their output set to zero) with a non-zero probability p>0 each time the neural network 102 processes a training input. Using the dropout regularization technique can improve the performance of the neural network 102, e.g., by reducing the likelihood of over-fitting. As another example, the training engine 116 can regularize the training of the neural network 102 by including a “penalty” term in the objective function that measures the magnitude of the model parameter values of the sub-networks 104, 108, 112. The penalty term can be, e.g., an L1 or L2 norm of the parameter values of the sub-networks 104, 108, 112.

The unsupervised training engine 117 will be described in more detail next.

The unsupervised training engine 117 can be configured to train one or more components of the system 100 over multiple training iterations in a biologically-plausible manner, e.g., using methods that are at least partially based on biological or neuroscientific principles. One such principle can be, e.g., that if a pair of biological neurons, where the first biological neuron is a presynaptic neuron, and the second biological neuron is a postsynaptic neuron, are repeatedly activated synchronously, the pair of biological neurons can become “associated” in the brain. When the biological neurons are associated, the activity of the first biological neuron can at least partially facilitate the activity of the second biological neuron, and vice versa. The correlation of the respective activations of the biological neurons (e.g., their “association”) can be reflected in an increase in the strength of a synapse that connects the pair of biological neurons in the brain.

The unsupervised training engine 117 can perform unsupervised updates of the values of brain emulation parameters 124 of the brain emulation sub-network 108 according to the aforementioned principle (e.g., in a biologically-plausible manner). In particular, as will be described in more detail below with reference to FIG. 7, each brain emulation parameter 124, when initialized, can represent a strength of a biological connection between a corresponding pair of biological neuronal elements in the brain of a biological organism. Each brain emulation parameter 124 can also represent an artificial connection between a corresponding pair of artificial neurons in the neural network 102. Accordingly, the unsupervised training engine 117 can update each brain emulation parameter 124 by, e.g., adjusting a “strength” of an artificial connection between a pair of artificial neurons that corresponds to each brain emulation parameter, based on the correlation of the activations of the respective pair of artificial neurons in the brain emulation sub-network 108.

Specifically, at each training iteration, the unsupervised training engine 117 can determine the activation values 127 of some, or all, of the artificial neurons included in the brain emulation sub-network 108, e.g., the activation values 127 generated by the artificial neurons in the brain emulation sub-network 108 during processing of the training input 101 by the neural network 102 to generate the training output 114. After determining the activation values 127, at each training iteration, the unsupervised training engine 117 can determine the correlations of the activation values 127 of each respective pair of artificial neurons in the brain emulation sub-network 108.

At each training iteration, based on the correlations of the activation values 127, the unsupervised training engine 117 can perform the unsupervised update of the values of the brain emulation parameters 124 by adjusting (e.g., increasing) the weights (e.g., the strength) of the respective connections between the corresponding pairs of artificial neurons, in a similar way as the strength of synapses connecting pairs of biological neurons in the brain would increase if the biological neurons were activated synchronously. The training engine 117 can adjust the weight of an artificial connection using any appropriate technique. A few examples follow.

In one example, the unsupervised training engine 117 can determine a change in weight Δwᵢⱼ of a connection between artificial neuron i and artificial neuron j, with respective activations xᵢ and xⱼ, as follows:

Δwᵢⱼ=ηxⱼxᵢ (1)

where η is a learning rate that can be, e.g., a hyperparameter of the neural network 102.

In particular, at each training iteration, the training engine 117 can receive the activation values 127 (e.g., xᵢ and xⱼ) generated by the artificial neurons in the brain emulation sub-network 108 during processing of the training input 101 to generate the training output 114, and compute the respective change in weight Δw of each respective connection between each pair of artificial neurons based on the correlation of their activation values. At each training iteration, the training engine 117 can accordingly adjust each brain emulation parameter 124 of the brain emulation sub-network 108 that corresponds to each respective pair of artificial neurons in the brain emulation sub-network 108, based on the correlation of their activation values, by an amount equal to the respective change in weight Δw.

As a particular example, for artificial neurons i and j, the unsupervised training engine 117 can determine new weight value as a sum (e.g., wᵢⱼ+Δwᵢⱼ) of the previous weight value Δwᵢⱼ of the connection between the artificial neurons i and j, e.g., the weight value of the connection before processing of the training input 101 to generate the training output 114 by the neural network 112, and the change in weight Δwᵢⱼ determined according to Equation 1 that resulted from processing of the training input 101 to generate the training output 114 by the neural network 102.

In another example, the unsupervised training engine 117 can determine a change in weight Δwᵢⱼ of a connection between artificial neuron i and artificial neuron j, with respective activations xᵢ and xⱼ, by applying a postsynaptic divisive normalization (e.g., L2 normalization factor), as follows:

$${Δ w}_{ij} = \frac{{η x}_{j} {x}_{i}}{{( {\sum }_{k} ( {w}_{kj} + {η x}_{j} {x}_{k} ) )}^{1 / 2}} - {w}_{ij} \qquad ( 2 )$$

where wᵢⱼ is the previous weight value of the connection between the artificial neurons i and j, and the sum is, e.g., over all artificial neurons that are connected by a connection to one of the artificial neurons in the pair, e.g., either artificial neuron i or artificial neuron j. As a particular example, for artificial neurons i and j, the unsupervised training engine 117 can determine new weight value as a sum (e.g., wᵢⱼ+Δwᵢⱼ) of the previous weight value wᵢⱼ of the connection between the artificial neurons i and j, e.g., the weight value of the connection before processing of the training input 101 to generate the training output 114 by the neural network 112, and the change in weight Δwᵢⱼ determined according to Equation 2 that resulted from processing of the training input 101 to generate the training output 114 by the neural network 102. The above example is provided for illustrative purposes only, and generally the unsupervised training engine 117 can apply any appropriate normalization factor to determine the change in weight Δwᵢⱼ.

In yet another example, the unsupervised training engine 117 can determine the change in weight Δwᵢⱼ of a connection between artificial neuron i and artificial neuron j, with respective activations xᵢ and xⱼ, as follows:

Δwᵢⱼ=ηxⱼxᵢ−ηxⱼwᵢⱼxᵢ (3)

Similarly as described above, the training engine 117 can determine new weight value as a sum (e.g., wᵢⱼ+Δwᵢⱼ) of the previous weight value wᵢⱼ of the connection between the artificial neurons i and j, e.g., the weight value of the connection before processing of the training input 101 to generate the training output 114 by the neural network 112, and the change in weight Δwᵢⱼ determined according to Equation 3 that resulted from processing of the training input 101 to generate the training output 114 by the neural network 102.

In yet another example, the unsupervised training engine 117 can determine the change in weight Δwᵢⱼ of a connection between artificial neuron i and artificial neuron j, with respective activations xᵢ and xⱼ, as follows:

Δwᵢⱼ=ηγ⁻¹(xⱼxᵢ−\tilde{x}ⱼ\tilde{x}ₗ) (4)

where xᵢ and xⱼ are the activation values of artificial neurons i and j, respectively, in a “free state,” e.g., in a state of the neural network 102 after processing training inputs 101 to generate training outputs 114 until convergence, \tilde{x}ₗ and \tilde{x}ⱼ are the activation values of artificial neurons i and j, respectively, in a “clamped state,” e.g., in a state of the neural network 102 after processing training inputs 101 to generate training outputs 114 until convergence but with one or more parameter values of the neural network 102 (e.g., one or more parameters of the decoder sub-network) held static, and γ⁻¹ is a contrastive factor that can have any appropriate value. An example technique for performing unsupervised updates to parameter values of a neural network based on free states and clamped states is described in more detail with reference to: Xie, Xiaohui, and H. Sebastian Seung, “Equivalence of backpropagation and contrastive Hebbian learning in a layered network,” Neural computation 15, no. 2 (2003): 441-454.

Similarly as described above, the training engine 117 can determine new weight value as a sum (e.g., wᵢⱼ+Δwᵢⱼ) of the previous weight value wᵢⱼ of the connection between the artificial neurons i and j, e.g., the weight value of the connection before processing of the training input 101 to generate the training output 114 by the neural network 112, and the change in weight Δwᵢⱼ determined according to Equation 4.

In some implementations, the unsupervised training engine 117 can also train the set of encoder sub-network parameters 122 and/or the set of decoder sub-network parameters 126 using any, or a combination, of the aforementioned techniques. In some implementations, the set of encoder sub-network parameters and/or the set of decoder sub-network parameters include brain emulation parameters that, when initialized, represent the synaptic connectivity graph. In such cases, the unsupervised training engine 117 can update the brain emulation parameters included in the set of encoder sub-network parameters and/or the decoder sub-network parameters using any, or a combination, of the aforementioned techniques.

The brains of biological organisms may be adapted by evolutionary pressures to be effective at solving certain tasks, e.g., classifying objects or generating robust object representations, and the brain emulation sub-network, having a set of brain emulation sub-network parameters that, when initialized, represent the synaptic connectivity graph, may share this capacity to effectively solve tasks. Training the brain emulation parameters of the brain emulation sub-network in a biologically-plausible manner, e.g., using training methods that are at least partially based on biological or neuroscientific principles, may enable optimally harnessing the innate ability of brain emulation sub-networks to effectively solve tasks. Therefore, training a neural network that includes the brain emulation sub-network using one or more techniques described above may require less training data and/or fewer training iterations. After training, the neural network may perform certain machine learning tasks more effectively, e.g., with higher accuracy, when compared to neural networks that include brain emulation sub-networks trained using non-biological training methods.

Example machine learning tasks that can be performed by the neural network 102 after training are described in more detail below.

In one example, the neural network 102 can be configured to process network inputs that represent sequences of audio data. For example, each input element in the network input can be a raw audio sample or an input generated from a raw audio sample (e.g., a spectrogram), and the neural network 102 can process the sequence of input elements to generate network outputs representing predicted text samples that correspond to the audio samples. That is, the neural network 102 can be a “speech-to-text” neural network. As another example, each input element can be a raw audio sample or an input generated from a raw audio sample, and the neural network 102 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, the weight matrix of the brain emulation sub-network 108 can be generated from a sub-graph of the synaptic connectivity graph corresponding to an audio region of the brain, i.e., a region of the brain that processes auditory information (e.g., the auditory cortex).

In another example, the neural network 102 can be configured to process network inputs that represent sequences of text data. For example, each input element in the network input can be a text sample (e.g., a character, phoneme, or word) or an embedding of a text sample, and the neural network 102 can process the sequence of input elements to generate network outputs representing predicted audio samples that correspond to the text samples. That is, the neural network 102 can be a “text-to-speech” neural network. As another example, each input element can be an input text sample or an embedding of an input text sample, and the neural network 102 can generate a network output representing a sequence of output text samples corresponding to the sequences of input text samples.

As a particular example, the output text samples can represent the same text as the input text samples in a different language (i.e., the neural network 102 can be a machine translation neural network). As another particular example, the output text samples can represent an answer to a question posed by the input text samples (i.e., the neural network 102 can be a question-answering neural network). As another example, the input text samples can represent two texts (e.g., as separated by a delimiter token), and the neural network 102 can generate a network output representing a predicted similarity between the two texts. In some implementations, the weight matrix of the brain emulation sub-network 108 can be generated from a sub-graph of the synaptic connectivity graph corresponding to a speech region of the brain, i.e., a region of the brain that is linked to speech production (e.g., Broca's area).

In another example, the neural network 102 can be configured to process network inputs representing one or more images, e.g., sequences of video frames. For example, each input element in the network input can be a video frame or an embedding of a video frame, and the neural network 102 can process the sequence of input elements to generate a network output 214 representing a prediction about the video represented by the sequence of video frames. As a particular example, the neural network 102 can be configured to track a particular object in each of the frames of the video, i.e., to generate a network output that includes a sequences of output elements, where each output element represents a predicted location within a respective video frames of the particular object. In some implementations the weight matrix of the brain emulation sub-network 108 can be generated from a sub-graph of the synaptic connectivity graph corresponding to a visual region of the brain, i.e., a region of the brain that processes visual information (e.g., the visual cortex).

In another example, the neural network 102 can be configured to process a network input representing a respective current state of an environment at each of one or more time points, and to generate a network output representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

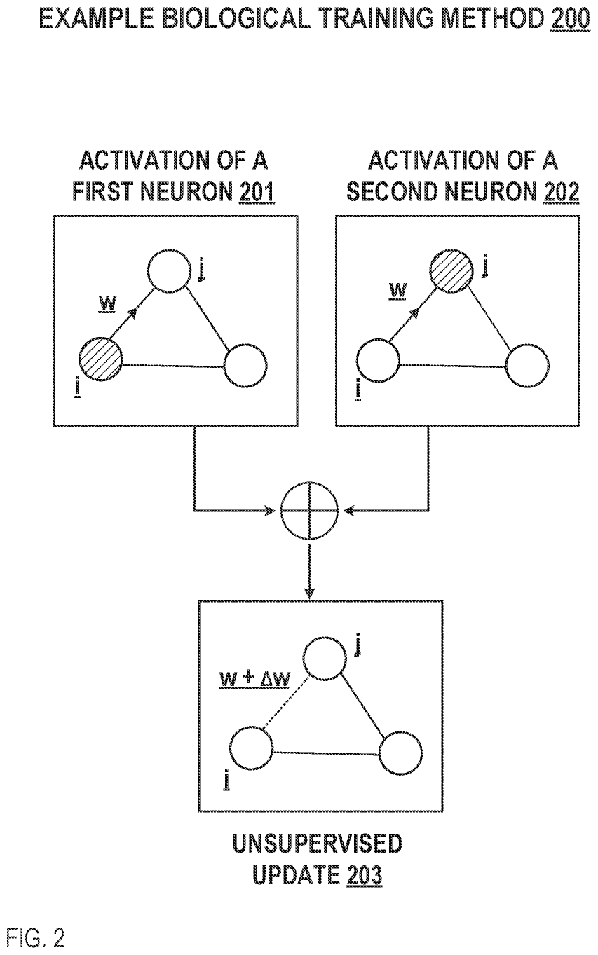

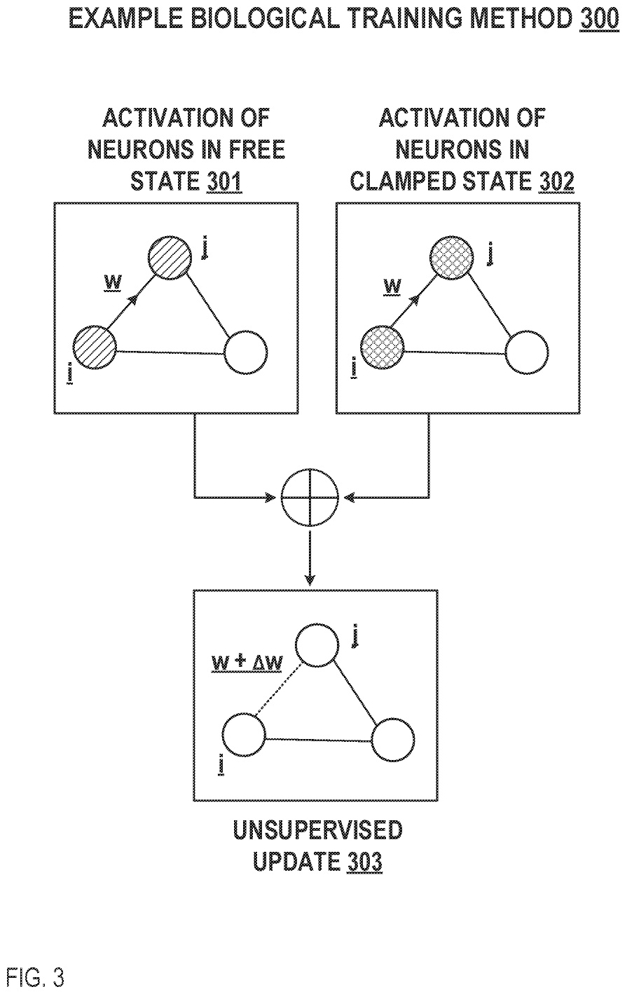

Example biologically-plausible training methods are described in more detail below with reference to FIG. 2 and FIG. 3.

FIG. 2 illustrates an example of a biologically-plausible training method 200. Artificial neurons in a neural network (e.g., the brain emulation sub-network 108 in FIG. 1) are represented by circles, and artificial connections between the artificial neurons are represented by solid lines.

For example, as illustrated in FIG. 2, a pair of artificial neurons i and j are connected by an artificial connection having a weight value w, where i is, e.g., a presynaptic neuron, and j is, e.g., a postsynaptic neuron. The activation of the first (e.g., presynaptic) neuron is shown by a dashed circle, and the activation of the second (e.g., postsynaptic) neuron is also shown by a dashed circle. As described above, when the neural network is used to process a training input to generate a training output, some artificial neurons that are connected by an artificial connection can have activation values that are correlated.

A training engine (e.g., the unsupervised training engine 117 in FIG. 1) can determine the correlation of the respective activations of artificial neuron i and artificial neuron j, and determine the change in weight Δw that resulted from their activation according to any of the Equations 1, 2, and 3 above. The training engine can accordingly determine a new value of the weight as a sum of the weight associated with the connection between the pair of artificial neurons before processing of the training input by the neural network (e.g., w in FIG. 2) and the change in weight Δw that resulted from the activation of the artificial neurons. The training engine can update the weight of the artificial connection in the neural network to the new value, e.g., as shown by the unsupervised update 203 in FIG. 2.

FIG. 3 illustrates another example of a biologically-plausible training method 300. Similarly as described above for FIG. 2, artificial neurons in a neural network (e.g., the brain emulation sub-network 108 in FIG. 1) are represented by circles, and artificial connections between the artificial neurons are represented by solid lines.

In some implementations, as described above, the neural network can be allowed to converge while processing training inputs to generate training outputs, which can be referred to as a “free state” of the neural network. The activations of artificial neurons i and j in the free state 301 are shown by dashed circles in the first panel. After convergence in the free state, some parameters of the neural network (e.g., parameters of the output layer of the neural network) can be held static, which can be referred to as a “clamped state.” The neural network can be allowed to converge again in the clamped state while processing training inputs to generate training outputs. After convergence, the activations of the same artificial neurons in the clamped state 302 are shown by checkered circles in the second panel.

A training engine (e.g., the unsupervised training engine 117 in FIG. 1) can determine the change in weight Δw that resulted from the activation of the pair of artificial neurons in free state 301, and the activation of the pair of artificial neurons in the clamped state 302, according Equation 4 above. The training engine can accordingly determine a new value of the weight as a sum of the weight associated with the connection between the pair of artificial neurons before processing of the training input by the neural network (e.g., w in FIG. 3) and the change in weight Δw that resulted from the activation of the artificial neurons in the free state and in the clamped state. The training engine can update the weight of the artificial connection in the neural network to the new value, e.g., as shown by the unsupervised update 303 in FIG. 3.

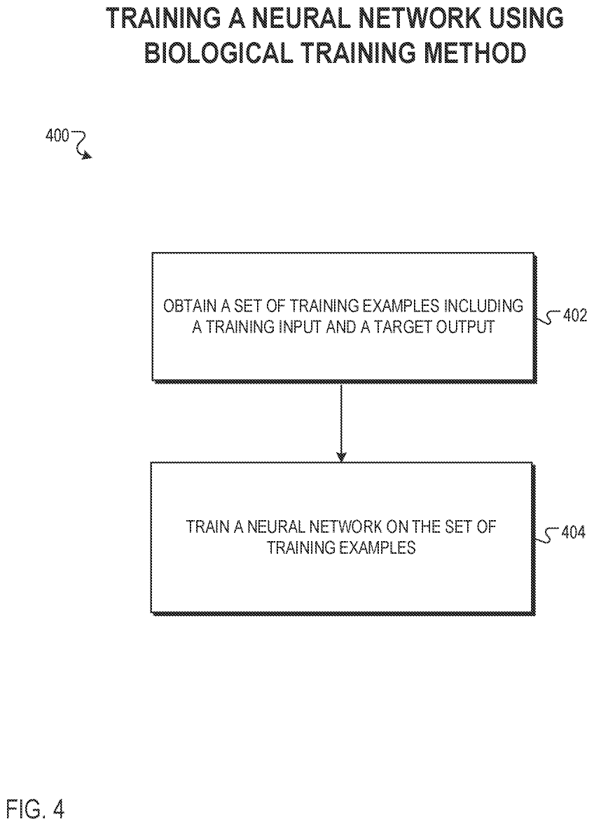

FIG. 4 is a flow diagram of an example process 400 for training a neural network (e.g., the neural network 102 in FIG. 2) using a biologically-plausible training method (e.g., the method 200 in FIG. 2, or the method 300 in FIG. 3). For convenience, the process 400 will be described as being performed by a system of one or more computers located in one or more locations, e.g., the neural network computing system 100 in FIG. 1.

The system obtains a set of training examples, where each training example includes: (i) a training input, and (ii) a target output (402).

The system trains the neural network on the set of training examples (404). This can include processing the training input from the training example using the neural network to generate a corresponding training output, including processing the training input using an encoder sub-network of the neural network, in accordance with a set of encoder sub-network parameters, to generate an embedding of the training input, processing the embedding of the training input using a brain emulation sub-network of the neural network, in accordance with a set of brain emulation sub-network parameters, to generate a brain emulation sub-network output, and processing the brain emulation sub-network output using a decoder sub-network of the neural network, in accordance with a set of decoder sub-network parameters, to generate the training output. Each brain emulation sub-network parameter, when initialized, can represent a strength of a biological connection between a pair of biological neuronal elements in a brain of a biological organism.

The system can update current values of at least the set of encoder sub-network parameters and the set of decoder sub-network parameters by a supervised update based on gradients of an objective function that measures an error between: (i) the training output, and (ii) the target output for the training example. The system can further update current values of at least the set of brain emulation sub-network parameters by an unsupervised update based on correlations between activation values generated by artificial neurons of the neural network during processing of the training input, by the neural network, to generate the training output.

Example process for generating a brain emulation neural network architecture, e.g., an architecture of a brain emulation sub-network (e.g., the brain emulation sub-network 108 in FIG. 1) having parameters that, when initialized, represent the synaptic connectivity graph, will be described in more detail next.

FIG. 5 is an example data flow 500 for generating a brain emulation neural network architecture 560 using a synaptic connectivity graph 530. A synaptic resolution image of the brain 515 of a biological organism 510, e.g., a fly can be processed to generate the synaptic connectivity graph 530, e.g., where each node in the graph 530 corresponds to a neuronal element in the brain 510, and two nodes in the graph 530 are connected if the corresponding neuronal elements in the brain 515 share a synaptic connection. An architecture mapping system 540 can use the structure of the graph 530 to specify the brain emulation neural network architecture 560. For example, each node in the graph 530 can mapped to an artificial neuron, a neural network layer, or a group of neural network layers in the brain emulation neural network architecture 560. Further, each edge of the graph 530 can be mapped to a connection between artificial neurons, layers, or groups of layers in the brain emulation neural network architecture 560. The brain 515 of the biological organism 510 can be adapted by evolutionary pressures to be effective at solving certain tasks, e.g., classifying objects or generating robust object representations, and a neural network having the brain emulation neural network architecture 560 can share this capacity to effectively solve tasks. Example architecture mapping system 540 will be described in more detail next.

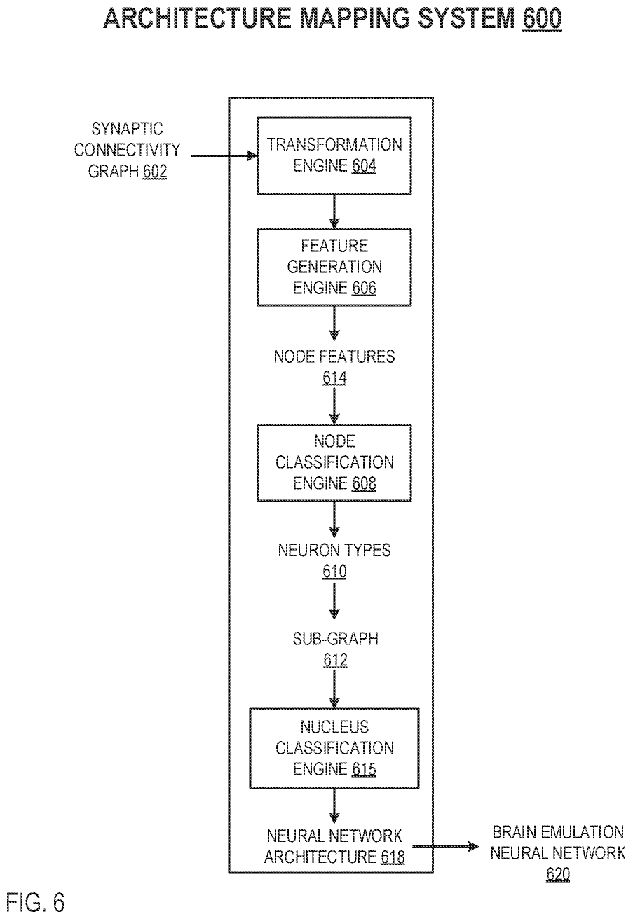

FIG. 6 is a block diagram of an example architecture mapping system 600. The architecture mapping system 600 is an example of a system implemented as computer programs on one or more computers in one or more locations in which the systems, components, and techniques described below are implemented.

The architecture mapping system 600 is configured to process a synaptic connectivity graph 602 (e.g., the synaptic connectivity graph 530 in FIG. 5) to determine a corresponding neural network architecture 618 of a brain emulation neural network 620 (e.g., the brain emulation sub-network 108 in FIG. 1). The architecture mapping system 600 can determine the architecture 618 using one or more of: a transformation engine 604, a feature generation engine 606, a node classification engine 608, and a nucleus classification engine 615, which will each be described in more detail next.

The transformation engine 604 can be configured to apply one or more transformation operations to the synaptic connectivity graph 602 that alter the connectivity of the graph 602, i.e., by adding or removing edges from the graph. A few examples of transformation operations follow.

In one example, to apply a transformation operation to the graph 602, the transformation engine 604 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 604 can modify the connectivity between the two nodes in the node pair with a predefined probability (e.g., 0.1%). In one example, the transformation engine 604 can connect the nodes by an edge (i.e., if they are not already connected by an edge) with the predefined probability. In another example, the transformation engine 604 can reverse the direction of any edge connecting the two nodes with the predefined probability. In another example, the transformation engine 604 can invert the connectivity between the two nodes with the predefined probability, i.e., by adding an edge between the nodes if they are not already connected, and by removing the edge between the nodes if they are already connected.

In another example, the transformation engine 604 can apply a convolutional filter to a representation of the graph 602 as a two-dimensional array of numerical values. As described above, the graph 602 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 604 can quantize the values in the array representing the graph, e.g., by rounding each value in the array to 0 or 1, to cause the array to unambiguously specify the connectivity of the graph. Applying a convolutional filter to the representation of the graph 602 can have the effect of regularizing the graph, e.g., by smoothing the values in the array representing the graph to reduce the likelihood of a component in the array having a different value than many of its neighbors.

In some cases, the graph 602 can include some inaccuracies in representing the synaptic connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The architecture mapping system 600 can use the feature generation engine 606 and the node classification engine 608 to determine predicted “types” 610 of the neuronal elements corresponding to the nodes in the graph 602. The type of a neuronal element can characterize any appropriate aspect of the neuronal element. In one example, the type of a neuronal element can characterize the function performed by the neuronal element in the brain, e.g., a visual function by processing visual data, an olfactory function by processing odor data, or a memory function by retaining information. After identifying the types of the neuronal elements corresponding to the nodes in the graph 602, the architecture mapping system 600 can identify a sub-graph 612 of the overall graph 602 based on the neuron types, and determine the neural network architecture 618 based on the sub-graph 612. The feature generation engine 606 and the node classification engine 608 are described in more detail next.

The feature generation engine 606 can be configured to process the graph 602 (potentially after it has been modified by the transformation engine 604) to generate one or more respective node features 614 corresponding to each node of the graph 602. The node features corresponding to a node can characterize the topology (i.e., connectivity) of the graph relative to the node. In one example, the feature generation engine 606 can generate a node degree feature for each node in the graph 602, where the node degree feature for a given node specifies the number of other nodes that are connected to the given node by an edge. In another example, the feature generation engine 606 can generate a path length feature for each node in the graph 602, where the path length feature for a node specifies the length of the longest path in the graph starting from the node. A path in the graph may refer to a sequence of nodes in the graph, such that each node in the path is connected by an edge to the next node in the path.

The length of a path in the graph may refer to the number of nodes in the path. In another example, the feature generation engine 606 can generate a neighborhood size feature for each node in the graph 602, where the neighborhood size feature for a given node specifies the number of other nodes that are connected to the node by a path of length at most N. In this example, N can be a positive integer value. In another example, the feature generation engine 606 can generate an information flow feature for each node in the graph 602. The information flow feature for a given node can specify the fraction of the edges connected to the given node that are outgoing edges, i.e., the fraction of edges connected to the given node that point from the given node to a different node.

In some implementations, the feature generation engine 606 can generate one or more node features that do not directly characterize the topology of the graph relative to the nodes. In one example, the feature generation engine 606 can generate a spatial position feature for each node in the graph 602, where the spatial position feature for a given node specifies the spatial position in the brain of the neuron corresponding to the node, e.g., in a Cartesian coordinate system of the synaptic resolution image of the brain. In another example, the feature generation engine 606 can generate a feature for each node in the graph 602 indicating whether the corresponding neuron is excitatory or inhibitory. In another example, the feature generation engine 606 can generate a feature for each node in the graph 602 that identifies the neuropil region associated with the neuron corresponding to the node.

In some cases, the feature generation engine 606 can use weights associated with the edges in the graph in determining the node features 614. As described above, a weight value for an edge connecting two nodes can be determined, e.g., based on the area of any overlap between tolerance regions around the neurons corresponding to the nodes. In one example, the feature generation engine 606 can determine the node degree feature for a given node as a sum of the weights corresponding to the edges that connect the given node to other nodes in the graph. In another example, the feature generation engine 606 can determine the path length feature for a given node as a sum of the edge weights along the longest path in the graph starting from the node.

The node classification engine 608 can be configured to process the node features 614 to identify a predicted neuron type 610 corresponding to certain nodes of the graph 602. In one example, the node classification engine 608 can process the node features 614 to identify a proper subset of the nodes in the graph 602 with the highest values of the path length feature. For example, the node classification engine 608 can identify the nodes with a path length feature value greater than the 90th percentile (or any other appropriate percentile) of the path length feature values of all the nodes in the graph. The node classification engine 608 can then associate the identified nodes having the highest values of the path length feature with the predicted neuron type of “primary sensory neuron.”

In another example, the node classification engine 608 can process the node features 614 to identify a proper subset of the nodes in the graph 602 with the highest values of the information flow feature, i.e., indicating that many of the edges connected to the node are outgoing edges. The node classification engine 608 can then associate the identified nodes having the highest values of the information flow feature with the predicted neuron type of “sensory neuron.” In another example, the node classification engine 608 can process the node features 614 to identify a proper subset of the nodes in the graph 602 with the lowest values of the information flow feature, i.e., indicating that many of the edges connected to the node are incoming edges (i.e., edges that point towards the node). The node classification engine 608 can then associate the identified nodes having the lowest values of the information flow feature with the predicted neuron type of “associative neuron.”

The architecture mapping system 600 can identify a sub-graph 612 of the overall graph 602 based on the predicted neuron types 610 corresponding to the nodes of the graph 602. A “sub-graph” may refer to a graph specified by: (i) a proper subset of the nodes of the graph 602, and (ii) a proper subset of the edges of the graph 602. In one example, the architecture mapping system 600 can select: (i) each node in the graph 602 corresponding to particular neuronal element type, and (ii) each edge in the graph 602 that connects nodes in the graph corresponding to the particular neuronal element type, for inclusion in the sub-graph 612. The neuronal element type selected for inclusion in the sub-graph can be, e.g., visual neurons, olfactory neurons, memory neurons, or any other appropriate type of neuronal elements. In some cases, the architecture mapping system 600 can select multiple neuronal element types for inclusion in the sub-graph 612, e.g., both visual neurons and olfactory neurons.

The type of neuronal element selected for inclusion in the sub-graph 612 can be determined based on the task which the brain emulation neural network 620 will be configured to perform. In one example, the brain emulation neural network 620 can be configured to perform an image processing task, and neuronal elements that are predicted to perform visual functions (i.e., by processing visual data) can be selected for inclusion in the sub-graph 612. In another example, the brain emulation neural network 620 can be configured to perform an odor processing task, and neuronal elements that are predicted to perform odor processing functions (i.e., by processing odor data) can be selected for inclusion in the sub-graph 612. In another example, the brain emulation neural network 620 can be configured to perform an audio processing task, and neuronal elements that are predicted to perform audio processing (i.e., by processing audio data) can be selected for inclusion in the sub-graph 612.

If the edges of the graph 602 are associated with weight values, then each edge of the sub-graph 612 can be associated with the weight value of the corresponding edge in the graph 602. The sub-graph 612 can be represented, e.g., as a two-dimensional array of numerical values, as described with reference to the graph 602.

Determining the architecture 618 of the brain emulation neural network 620 based on the sub-graph 612 rather than the overall graph 602 can result in the architecture 618 having a reduced complexity, e.g., because the sub-graph 612 has fewer nodes, fewer edges, or both than the graph 602. Reducing the complexity of the architecture 618 can reduce consumption of computational resources (e.g., memory and computing power) by the brain emulation neural network 620, e.g., enabling the brain emulation neural network 620 to be deployed in resource-constrained environments, e.g., mobile devices. Reducing the complexity of the architecture 618 can also facilitate training of the brain emulation neural network 620, e.g., by reducing the amount of training data required to train the brain emulation neural network 620 to achieve an threshold level of performance (e.g., prediction accuracy).

In some cases, the architecture mapping system 600 can further reduce the complexity of the architecture 618 using a nucleus classification engine 615. In particular, the architecture mapping system 600 can process the sub-graph 612 using the nucleus classification engine 615 prior to determining the architecture 618. The nucleus classification engine 615 can be configured to process a representation of the sub-graph 612 as a two-dimensional array of numerical values (as described above) to identify one or more “clusters” in the array.

A cluster in the array representing the sub-graph 612 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 615 can identify contiguous regions of the array such that at least a threshold fraction of the components in the region have the value 1. The nucleus classification engine 615 can identify clusters in the array representing the sub-graph 612 by processing the array using a blob detection algorithm, e.g., by convolving the array with a Gaussian kernel and then applying the Laplacian operator to the array. After applying the Laplacian operator, the nucleus classification engine 615 can identify each component of the array having a value that satisfies a predefined threshold as being included in a cluster.

Each of the clusters identified in the array representing the sub-graph 612 can correspond to edges connecting a “nucleus” (i.e., group) of related neuronal elements in brain, e.g., a thalamic nucleus, a vestibular nucleus, a dentate nucleus, or a fastigial nucleus. After the nucleus classification engine 615 identifies the clusters in the array representing the sub-graph 612, the architecture mapping system 600 can select one or more of the clusters for inclusion in the sub-graph 612. The architecture mapping system 600 can select the clusters for inclusion in the sub-graph 612 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 600 can select a predefined number of largest clusters (i.e., that include the greatest number of edges) for inclusion in the sub-graph 612.

The architecture mapping system 600 can reduce the sub-graph 612 by removing any edge in the sub-graph 612 that is not included in one of the selected clusters, and then map the reduced sub-graph 612 to a corresponding neural network architecture, as will be described in more detail below. Reducing the sub-graph 612 by restricting it to include only edges that are included in selected clusters can further reduce the complexity of the architecture 618, thereby reducing computational resource consumption by the brain emulation neural network 620 and facilitating training of the brain emulation neural network 620.

The architecture mapping system 600 can determine the architecture 618 of the brain emulation neural network 620 from the sub-graph 612 in any of a variety of ways. For example, the architecture mapping system 600 can map each node in the sub-graph 612 to a corresponding: (i) artificial neuron, (ii) artificial neural network layer, or (iii) group of artificial neural network layers in the architecture 618, as will be described in more detail next.

In one example, the neural network architecture 618 can include: (i) a respective artificial neuron corresponding to each node in the sub-graph 612, and (ii) a respective connection corresponding to each edge in the sub-graph 612. In this example, the sub-graph 612 can be a directed graph, and an edge that points from a first node to a second node in the sub-graph 612 can specify a connection pointing from a corresponding first artificial neuron to a corresponding second artificial neuron in the architecture 618. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 618 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 5 )$$

where σ(·) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 612 can be an undirected graph, and the architecture mapping system 600 can map an edge that connects a first node to a second node in the sub-graph 612 to two connections between a corresponding first artificial neuron and a corresponding second artificial neuron in the architecture. In particular, the architecture mapping system 600 can map the edge to: (i) a first connection pointing from the first artificial neuron to the second artificial neuron, and (ii) a second connection pointing from the second artificial neuron to the first artificial neuron.

In another example, the sub-graph 612 can be an undirected graph, and the architecture mapping system can map an edge that connects a first node to a second node in the sub-graph 612 to one connection between a corresponding first artificial neuron and a corresponding second artificial neuron in the architecture. The architecture mapping system 600 can determine the direction of the connection between the first artificial neuron and the second artificial neuron, e.g., by randomly sampling the direction in accordance with a probability distribution over the set of two possible directions.

In some cases, the edges in the sub-graph 612 are not associated with weight values, and the weight values corresponding to the connections in the architecture 618 can be determined randomly. For example, the weight value corresponding to each connection in the architecture 618 can be randomly sampled from a predetermined probability distribution, e.g., a standard Normal (N(0,1)) probability distribution.

In another example, the neural network architecture 618 can include: (i) a respective artificial neural network layer corresponding to each node in the sub-graph 612, and (ii) a respective connection corresponding to each edge in the sub-graph 612. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 618 can include a respective convolutional neural network layer corresponding to each node in the sub-graph 612, and each given convolutional layer can generate an output d as:

$$d = σ ( {h}_{θ} ( {\sum }_{i = 1}^{n} {w}_{i} \cdot {c}_{i} ) ) \qquad ( 6 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(·) represents the operation of applying one or more convolutional kernels to an input to generate a corresponding output, and σ(·) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 600 can determine that the neural network architecture includes: (i) a respective group of artificial neural network layers corresponding to each node in the sub-graph 612, and (ii) a respective connection corresponding to each edge in the sub-graph 612. The layers in a group of artificial neural network layers corresponding to a node in the sub-graph 612 can be connected, e.g., as a linear sequence of layers, or in any other appropriate manner.

The neural network architecture 618 can include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network 620. An output artificial neural neuron may refer to an artificial neuron that generates an output which is considered part of the overall output generated by the brain emulation neural network 620.

Various operations performed by the described architecture mapping system 600 are optional or can be implemented in a different order. For example, the architecture mapping system 600 can refrain from applying transformation operations to the graph 602 using the transformation engine 604, and refrain from extracting a sub-graph 612 from the graph 602 using the feature generation engine 606, the node classification engine 608, and the nucleus classification engine 615. In this example, the architecture mapping system 600 can directly map the graph 602 to the neural network architecture 618, e.g., by mapping each node in the graph to an artificial neuron and mapping each edge in the graph to a connection in the architecture, as described above.

FIG. 7 illustrates an example adjacency matrix 700 and an example weight matrix 710 of a brain emulation neural network (e.g., brain emulation sub-network 108 in FIG. 1) determined using synaptic connectivity.

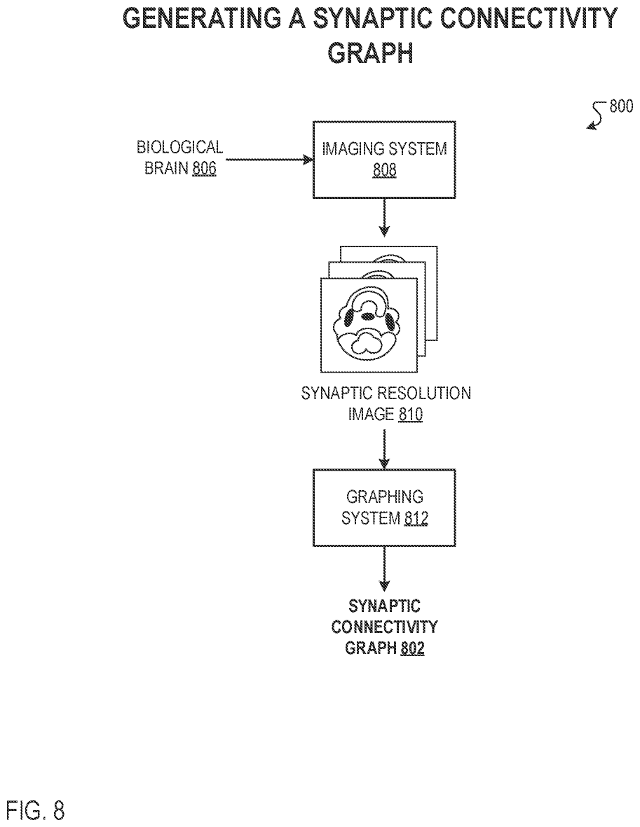

As described in more detail below with reference to FIG. 8, a graphing system (e.g., the graphing system 812 depicted in FIG. 8), can generate a synaptic connectivity graph that represents synaptic connectivity between biological neuronal elements in the brain of a biological organism. The synaptic connectivity graph can be represented using an adjacency matrix 700, all of which or a portion of which can be used as the weight matrix 710 of the brain emulation neural network.

As illustrated in FIG. 7, the adjacency matrix 700 includes n² elements, where n is the number of neuronal elements drawn from the brain of the biological organism. For example, the adjacency matrix 700 can include hundreds, thousands, tens of thousands, hundreds of thousands, millions, tens of millions, or hundreds of millions of elements.

Each element of the adjacency matrix 700 represents the synaptic connectivity between a respective pair of neuronal elements in the set of neuronal elements. That is, each element c_{i,j} identifies the synaptic connection between neuronal element i and neuronal element j. In some implementations, each of the elements c_{i,j} are either zero (e.g., when there is no biological connection between the corresponding neuronal elements) or one (e.g., when there exists a biological connection between the corresponding neuronal elements), while in some other implementations, each element c_{i,j} is a scalar value representing the strength of the biological connection between the corresponding neuronal elements.

Each row of the adjacency matrix 700 can represent a respective neuronal element in a first set of neuronal elements in the brain of the biological organism, and each column of the adjacency matrix 700 can represent a respective neuronal element in a second set of neuronal elements in the brain of the biological organism. Generally, the first set and the second set can be overlapping or disjoint. As a particular example, the first set and the second set can be the same.

In some implementations (e.g., when the synaptic connectivity graph is a undirected graph), the adjacency matrix 700 is symmetric (i.e., each element c_{i,j} is the same as element cᵢᵢ), while in some other implementations (e.g., in implementations in which the synaptic connectivity graph is directed), the adjacency matrix 700 is not symmetric (i.e., there may exist elements c_{i,j} and c_{j,i} such that that c_{i,j}≠c_{j,i}).

Although the above description refers to neuronal elements in the brain of the biological organism, generally the elements of the adjacency matrix can correspond to pairs of any appropriate component of the brain of the biological organism. For example, each element can correspond to a pair of voxels in a voxel grid of the brain of the biological organism. As another example, each element can correspond to a pair of sub-neurons of the brain of the biological organism. As another example, each element can correspond to a pair of sets of multiple neurons of the brain of the biological organism.

As described in more detail above with reference to FIG. 6, an architecture mapping system 540 (e.g., the architecture mapping system 600 in FIG. 6) can generate the weight matrix 710 from the adjacency matrix 700. Generally, the elements of the weight matrix 710 (i.e., the brain emulation sub-network parameters 124 in FIG. 1) are a subset of the elements of the adjacency matrix 700. For example, as illustrated in FIG. 7, the weight matrix 710 includes the elements of the adjacency matrix 700 representing biological connections between the biological neuronal elements represented by the first three rows and first three columns of the adjacency matrix 700. In some implementations, the weight matrix 710 can represent neuronal elements only of a particular type. The process for identifying different types of neuronal elements is described above with reference to FIG. 6.

Although the weight matrix 710 is illustrated as having only nine brain emulation parameters, generally, weight matrices of brain emulation neural network layers can have significantly more brain emulation parameters, e.g., hundreds, thousands, or millions, of brain emulation parameters. Further, the weight matrix 710 can have any appropriate dimensionality.

In some implementations, the weight matrix 710 can represent the entire synaptic connectivity graph. That is, the weight matrix 710 can include a respective row and column for each node of the synaptic connectivity graph.

FIG. 8 is an example data flow 800 for generating a synaptic connectivity graph 802 based on the brain 806 of a biological organism.

An imaging system 808 can be used to generate a synaptic resolution image 810 of the brain 806. An image of the brain 806 may be referred to as having synaptic resolution if it has a spatial resolution that is sufficiently high to enable the identification of at least some synapses in the brain 806. Put another way, an image of the brain 806 may be referred to as having synaptic resolution if it depicts the brain 806 at a magnification level that is sufficiently high to enable the identification of at least some synapses in the brain 806. The image 810 can be a volumetric image, i.e., that characterizes a three-dimensional representation of the brain 806. The image 810 can be represented in any appropriate format, e.g., as a three-dimensional array of numerical values.

The imaging system 808 can be any appropriate system capable of generating synaptic resolution images, e.g., an electron microscopy system. The imaging system 808 can process “thin sections” from the brain 806 (i.e., thin slices of the brain attached to slides) to generate output images that each have a field of view corresponding to a proper subset of a thin section. The imaging system 808 can generate a complete image of each thin section by stitching together the images corresponding to different fields of view of the thin section using any appropriate image stitching technique.

The imaging system 808 can generate the volumetric image 810 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

In some implementations, the imaging system 808 can be a two-photon endomicroscopy system that utilizes a miniature lens implanted into the brain to perform fluorescence imaging. This system enables in-vivo imaging of the brain at the synaptic resolution. Example techniques for generating a synaptic resolution image of the brain using two-photon endomicroscopy are described with reference to: Z. Qin, et al., “Adaptive optics two-photon endomicroscopy enables deep-brain imaging at synaptic resolution over large volumes,” Science Advances, Vol. 6, no. 40, doi: 10.1126/sciadv.abc6521.

A graphing system 812 is configured to process the synaptic resolution image 810 to generate the synaptic connectivity graph 802. The synaptic connectivity graph 802 specifies a set of nodes and a set of edges, such that each edge connects two nodes. To generate the graph 802, the graphing system 812 identifies each neuronal element (e.g., a neuron, a group of neurons, or a portion of a neuron) in the image 810 as a respective node in the graph, and identifies each biological connection between a pair of neuronal elements in the image 810 as an edge between the corresponding pair of nodes in the graph.

The graphing system 812 can identify the neuronal elements and biological connections between neuronal elements depicted in the image 810 using any of a variety of techniques. For example, the graphing system 812 can process the image 810 to identify the positions of the neurons depicted in the image 810, and determine whether a biological connection exists between two neurons based on the proximity of the neurons (as will be described in more detail below).

In this example, the graphing system 812 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 812 can identify contiguous clusters of voxels in the neuron probability map as being neurons.

Optionally, prior to identifying the neurons from the neuron probability map, the graphing system 812 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 812 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 810 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 812 can identify biological connections between neuronal elements in the image 810 based on the proximity of the neuronal elements. For example, the graphing system 812 can determine that a first neuronal element is connected by a biological connection to a second neuronal element based on the area of overlap between: (i) a tolerance region in the image around the first neuronal element, and (ii) a tolerance region in the image around the second neuronal element. That is, the graphing system 812 can determine whether the first neuronal element and the second neuronal element are connected based on the number of spatial locations (e.g., voxels) that are included in both: (i) the tolerance region around the first neuronal element, and (ii) the tolerance region around the second neuronal element.

As a particular example, the graphing system 812 can determine that two neurons are connected if the overlap between the tolerance regions around the respective neurons includes at least a predefined number of spatial locations (e.g., one spatial location). A “tolerance region” around a neuronal element refers to a contiguous region of the image that includes the neuronal element. As a particular example, the tolerance region around a neuron can be specified as the set of spatial locations in the image that are either: (i) in the interior of the neuron, or (ii) within a predefined distance of the interior of the neuron.

The graphing system 812 can further identify a weight value associated with each edge in the graph 802. For example, the graphing system 812 can identify a weight for an edge connecting two nodes in the graph 802 based on the area of overlap between the tolerance regions around the respective neurons (or any other neuronal elements) corresponding to the nodes in the image 810 (e.g., based on a proximity of the respective neurons or other neuronal elements). The area of overlap can be measured, e.g., as the number of voxels in the image 810 that are contained in the overlap of the respective tolerance regions around the neurons. The weight for an edge connecting two nodes in the graph 802 may be understood as characterizing the (approximate) strength of the biological connection between the corresponding neuronal elements in the brain (e.g., the amount of information flow through the biological connection connecting the two neuronal elements).

In addition to identifying biological connections in the image 810, the graphing system 812 can further determine the direction of each biological connection using any appropriate technique. The “direction” of a biological connection between two neuronal elements refers to the direction of information flow between the two neuronal elements, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 812 determines the directions of the synapses in the image 810, the graphing system 812 can associate each edge in the graph 802 with the direction of the corresponding synapse. That is, the graph 802 can be a directed graph. In some other implementations, the graph 802 can be an undirected graph, i.e., where the edges in the graph are not associated with a direction.

The graph 802 can be represented in any of a variety of ways. For example, the graph 802 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 812 determines a weight value for each edge in the graph 802, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

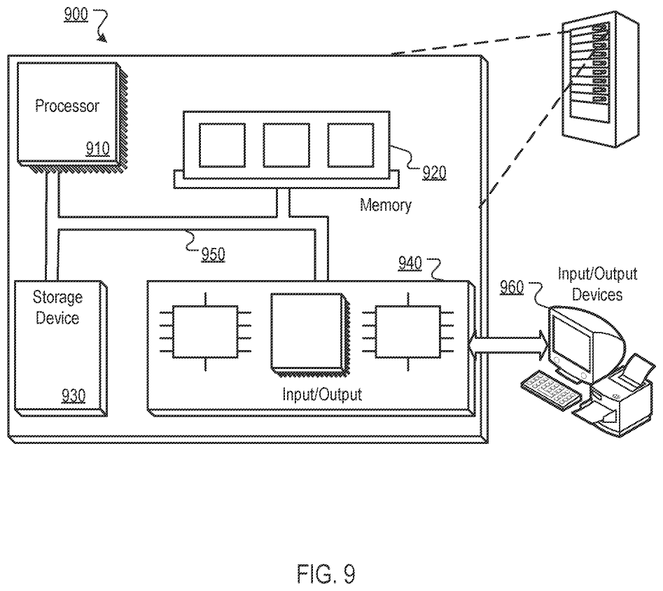

FIG. 9 is a block diagram of an example computer system 900 that can be used to perform operations described previously. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can include, for example, a hard disk device, an optical disk device, a storage device that is shared over a network by multiple computing devices (for example, a cloud storage device), or some other large capacity storage device.

The input/output device 940 provides input/output operations for the system 900. In one implementation, the input/output device 940 can include one or more network interface devices, for example, an Ethernet card, a serial communication device, for example, and RS-232 port, and/or a wireless interface device, for example, and 802.11 card. In another implementation, the input/output device 940 can include driver devices configured to receive input data and send output data to other input/output devices, for example, keyboard, printer and display devices 960. Other implementations, however, can also be used, such as mobile computing devices, mobile communication devices, and set-top box television client devices.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus for training a neural network, the method comprising:
obtaining a set of training examples, wherein each training example comprises: (i) a training input, and (ii) a target output; and
training the neural network on the set of training examples, comprising, for each training example:
processing the training input from the training example using the neural network to generate a corresponding training output, comprising:
processing the training input using an encoder sub-network of the neural network, in accordance with a set of encoder sub-network parameters, to generate an embedding of the training input;
processing the embedding of the training input using a brain emulation sub-network of the neural network, in accordance with a set of brain emulation sub-network parameters, to generate a brain emulation sub-network output,
wherein the brain emulation sub-network parameters, when initialized, represent biological connections between a plurality of biological neuronal elements in a brain of a biological organism; and
processing the brain emulation sub-network output using a decoder sub-network of the neural network, in accordance with a set of decoder sub-network parameters, to generate the training output;
updating current values of at least the set of encoder sub-network parameters and the set of decoder sub-network parameters by a supervised update based on gradients of an objective function that measures an error between: (i) the training output, and (ii) the target output for the training example; and
updating current values of at least the set of brain emulation sub-network parameters by an unsupervised update based on correlations between activation values generated by artificial neurons of the neural network during processing of the training input, by the neural network, to generate the training output.

2. The method of claim 1, wherein each brain emulation sub-network parameter corresponds to a respective pair of biological neuronal elements in the brain of the biological organism, and wherein a value of each brain emulation sub-network parameter, when initialized, represents a strength of a biological connection between the corresponding pair of biological neuronal elements in the brain of the biological organism.

3. The method of claim 1, further comprising updating current values of at least the set of brain emulation sub-network parameters by the supervised update based on gradients of the objective function that measures the error between: (i) the training output, and (ii) the target output for the training example.

4. The method of claim 1, wherein each brain emulation sub-network parameter corresponds to a respective pair of artificial neurons in the brain emulation sub-network.

5. The method of claim 4, wherein updating current values of at least the set of brain emulation sub-network parameters by the unsupervised update based on correlations between activation values generated by the artificial neurons of the neural network during processing of the training input, by the neural network, to generate the training output comprises:
receiving the activation values generated by the artificial neurons of the brain emulation sub-network during processing of the training input;
determining, for each brain emulation sub-network parameter in the set of brain emulation sub-network parameters, a correlation between the respective activation values of the artificial neurons corresponding to the brain emulation sub-network parameter;
determining, for each brain emulation sub-network parameter and based on the correlation of the respective activation values, a new value of the brain emulation sub-network parameter; and
updating the current value of each brain emulation sub-network parameter in the set of brain emulation sub-network parameters to the respective new value.

6. The method of claim 5, wherein determining, for each brain emulation sub-network parameter and based on the correlation of the respective activation values, the new value of the brain emulation sub-network parameter, comprises:
determining the new value based, at least in part, on a product of a learning rate and the activation values of the pair of artificial neurons in the brain emulation sub-network that correspond to the brain emulation sub-network parameter, wherein the product characterizes a measure of correlation of the respective activation values of the pair of artificial neurons.

7. The method of claim 6, wherein the learning rate is a hyperparameter of the neural network.

8. The method of claim 6, wherein the product of the learning rate and the activation values of the pair of artificial neurons in the brain emulation sub-network is normalized using an L2 norm.

9. The method of claim 6, wherein determining the new value of the brain emulation sub-network parameter based, at least in part, on the product of the learning rate and the activation values of the pair of artificial neurons in the brain emulation sub-network that correspond to the brain emulation sub-network parameter comprises:
determining the new value of the brain emulation sub-network parameter by combining the current value of the brain emulation sub-network parameter, and the product of the learning rate and the activation values of the pair of artificial neurons in the brain emulation sub-network that correspond to the brain emulation sub-network parameter.

10. The method of claim 5, wherein receiving the activation values generated by the artificial neurons of the brain emulation sub-network during processing of the training input comprises:
receiving activation values generated by the artificial neurons of the brain emulation sub-network in a free state of the neural network; and
receiving activation values generated by the artificial neurons of the brain emulation sub-network in a clamped state of the neural network.

11. The method of claim 10, wherein determining, for each brain emulation sub-network parameter and based on the correlation of the respective activation values, the new value of the brain emulation sub-network parameter comprises:
determining the new value of the brain emulation sub-network parameter based, at least in part, on the activation values generated by the artificial neurons of the brain emulation sub-network that correspond to the brain emulation sub-network parameter in the free state of the neural network, the activation values generated by the artificial neurons of the brain emulation sub-network that correspond to the brain emulation parameter in the clamped state of the neural network, and a learning rate.

12. The method of claim 1, wherein the set of encoder sub-network parameters and the set of decoder sub-network parameters each include brain emulation parameters that, when initialized, represent biological connections between the plurality of biological neuronal elements in the brain of the biological organism.

13. The method of claim 12, further comprising:
updating current values of the brain emulation parameters included in the set of encoder sub-network parameters and the set of decoder sub-network parameters by the unsupervised update based on correlations between activation values generated by artificial neurons of the neural network during processing of the training input, by the neural network, to generate the training output.

14. The method of claim 1, wherein the set of brain emulation sub-network parameters are determined from a synaptic resolution image of at least a portion of the brain of the biological organism, the determining comprising:
processing the synaptic resolution image to identify: (i) the plurality of biological neuronal elements, and (ii) a plurality of biological connections between pairs of biological neuronal elements;
determining a respective value of each brain emulation sub-network parameter, comprising:
setting a value of each brain emulation sub-network parameter that corresponds to a pair of biological neuronal elements in the brain that are not connected by a biological connection to zero; and
setting a value of each brain emulation sub-network parameter that corresponds to a pair of biological neuronal elements in the brain that are connected by a biological connection based on a proximity of the pair of biological neuronal elements in the brain.

15. The method of claim 1, wherein each biological neuronal element of the plurality of biological neuronal elements is a biological neuron, a part of a biological neuron, or a group of biological neurons.

16. The method of claim 1, wherein the set of brain emulation sub-network parameters are arranged in a two-dimensional weight matrix having a plurality of rows and a plurality of columns,
wherein each row and each column of the weight matrix corresponds to a respective biological neuronal element from the plurality of biological neuronal elements, and
wherein each brain emulation sub-network parameter in the weight matrix corresponds to a respective pair of biological neuronal elements in the brain of the biological organism, the pair comprising: (i) the biological neuronal element corresponding to a row of the brain emulation sub-network parameter in the weight matrix, and (ii) the biological neuronal element corresponding to a column of the brain emulation sub-network parameter in the weight matrix.

17. The method of claim 16, wherein each brain emulation sub-network parameter of the weight matrix that corresponds to a respective pair of biological neuronal elements that are not connected by a biological connection in the brain of the biological organism has value zero, and wherein each brain emulation sub-network parameter of the weight matrix that corresponds to a respective pair of biological neuronal elements that are connected by a biological connection in the brain of the biological organism has a respective non-zero value characterizing an estimated strength of the biological connection.

18. The method of claim 17, wherein updating current values of at least the set of brain emulation sub-network parameters by the unsupervised update based on correlations between activation values generated by artificial neurons of the neural network during processing of the training input, by the neural network, to generate the training output, comprises:
updating only the brain emulation parameters of the weight matrix having non-zero values.

19. A system comprising:
one or more computers; and
one or more storage devices communicatively coupled to the one or more computers, wherein the one or more storage devices store instructions that, when executed by the one or more computers, cause the one or more computers to perform operations for training a neural network, the operations comprising:
obtaining a set of training examples, wherein each training example comprises: (i) a training input, and (ii) a target output; and
training the neural network on the set of training examples, comprising, for each training example:
processing the training input from the training example using the neural network to generate a corresponding training output, comprising:
processing the training input using an encoder sub-network of the neural network, in accordance with a set of encoder sub-network parameters, to generate an embedding of the training input;
processing the embedding of the training input using a brain emulation sub-network of the neural network, in accordance with a set of brain emulation sub-network parameters, to generate a brain emulation sub-network output,
wherein the brain emulation sub-network parameters, when initialized, represent biological connections between a plurality of biological neuronal elements in a brain of a biological organism; and
processing the brain emulation sub-network output using a decoder sub-network of the neural network, in accordance with a set of decoder sub-network parameters, to generate the training output;
updating current values of at least the set of encoder sub-network parameters and the set of decoder sub-network parameters by a supervised update based on gradients of an objective function that measures an error between: (i) the training output, and (ii) the target output for the training example; and
updating current values of at least the set of brain emulation sub-network parameters by an unsupervised update based on correlations between activation values generated by artificial neurons of the neural network during processing of the training input, by the neural network, to generate the training output.

20. One or more non-transitory computer storage media storing instructions that when executed by one or more computers cause the one or more computers to perform operations for training a neural network, the operations comprising:
obtaining a set of training examples, wherein each training example comprises: (i) a training input, and (ii) a target output; and
training the neural network on the set of training examples, comprising, for each training example:
processing the training input from the training example using the neural network to generate a corresponding training output, comprising:
processing the training input using an encoder sub-network of the neural network, in accordance with a set of encoder sub-network parameters, to generate an embedding of the training input;
processing the embedding of the training input using a brain emulation sub-network of the neural network, in accordance with a set of brain emulation sub-network parameters, to generate a brain emulation sub-network output,
wherein the brain emulation sub-network parameters, when initialized, represent biological connections between a plurality of biological neuronal elements in a brain of a biological organism; and
processing the brain emulation sub-network output using a decoder sub-network of the neural network, in accordance with a set of decoder sub-network parameters, to generate the training output;
updating current values of at least the set of encoder sub-network parameters and the set of decoder sub-network parameters by a supervised update based on gradients of an objective function that measures an error between: (i) the training output, and (ii) the target output for the training example; and
updating current values of at least the set of brain emulation sub-network parameters by an unsupervised update based on correlations between activation values generated by artificial neurons of the neural network during processing of the training input, by the neural network, to generate the training output.
